(19) United States
(12) Patent Application Publication
(10) Pub. No.: US 2024/0257014 A1
(43) Pub. Date: Aug. 1, 2024

(54) INSIGHT LINEAGE TRACKING

(71) Applicant: Dell Products L.P., Round Rock, TX (US)

(72) Inventors: Robert Anthony Lincourt, JR., Franklin, MA (US); Stephen James Todd, North Andover, MA (US); Eloy Francisco Macha, Crowley, TX (US)

(21) Appl. No.: 18/162,355

(22) Filed: Jan. 31, 2023

(51) Int. Cl. G06Q 10/0637; G06Q 10/10

(52) U.S. Cl. CPC G06Q 10/0637; G06Q 10/103

(57) ABSTRACT

A method and system for insight lineage tracking. Any insight may be defined as a finding (or more broadly, as useful knowledge) gained through data analytics or, more precisely, through the discovery of patterns and/or relationships amongst any given assortment of data/information. Accordingly, any insight may be derived, or inferred, from any number of data/information items, including any number of other insights, as well as any number of employed analytic algorithms or models. In aiming to track these insight-pertinent objects, as well as the dependencies there-between, embodiments disclosed herein create insight lineage graphs visually conveying said objects and dependencies and, moreover, maintain metadata descriptive of each step in an insight creation process leading to the production of insights.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for tracking insight lineage. The method includes: detecting an initiation, by an organization user, of an insight editing program; monitoring interactions, by the organization user, with the insight editing program to identify an engagement action, wherein the engagement action reflects a creating of an insight editing file to be associated with an insight; generating an insight lineage graph reflecting a null graph; mapping the insight lineage graph to the insight editing file; monitoring second interactions, by the organization user, with the insight editing file to identify an insight creation action; and amending, based on the insight creation action, the insight lineage graph to track an insight lineage for the insight.

In general, in one aspect, embodiments disclosed herein relate to a non-transitory computer readable medium (CRM). The non-transitory CRM includes computer readable program code, which when executed by a computer processor, enables the computer processor to perform a method for tracking insight lineage. The method includes: detecting an initiation, by an organization user, of an insight editing program; monitoring interactions, by the organization user, with the insight editing program to identify an engagement action, wherein the engagement action reflects a creating of an insight editing file to be associated with an insight; generating an insight lineage graph reflecting a null graph; mapping the insight lineage graph to the insight editing file; monitoring second interactions, by the organization user, with the insight editing file to identify an insight creation action; and amending, based on the insight creation action, the insight lineage graph to track an insight lineage for the insight.

In general, in one aspect, embodiments disclosed herein relate to a system. The system includes: a client device; and an insight service operatively connected to the client device, and including a computer processor configured to perform a method for tracking insight lineage. The method includes: detecting an initiation, by an organization user operating the client device, of an insight editing program executing on the client device; monitoring interactions, by the organization user, with the insight editing program to identify an engagement action, wherein the engagement action reflects a creating of an insight editing file to be associated with an insight; generating an insight lineage graph reflecting a null graph; mapping the insight lineage graph to the insight editing file; monitoring second interactions, by the organization user, with the insight editing file to identify an insight creation action; and amending, based on the insight creation action, the insight lineage graph to track an insight lineage for the insight.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIGS. 3A-3C show flowcharts describing a method for insight lineage tracking in accordance with one or more embodiments disclosed herein.

FIG. 4 shows an example computing system in accordance with one or more embodiments disclosed herein.

FIGS. 5A-5C show an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

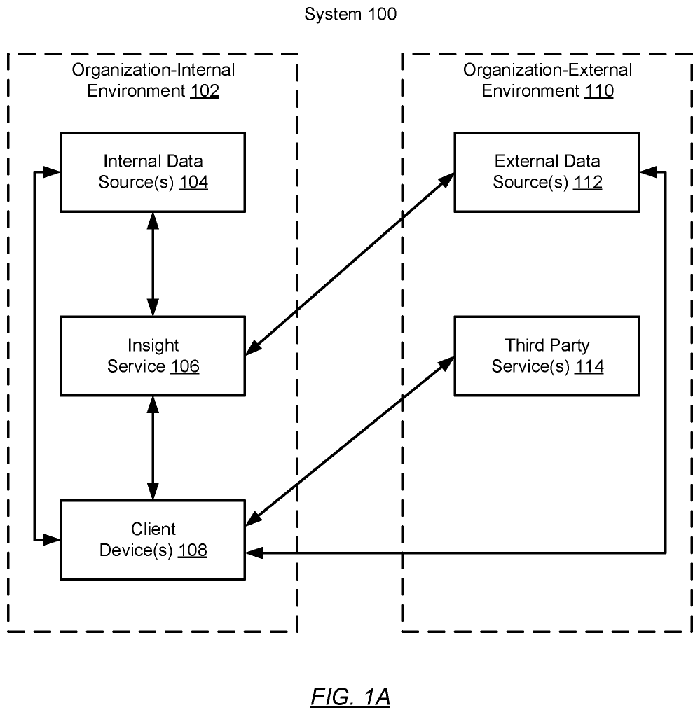

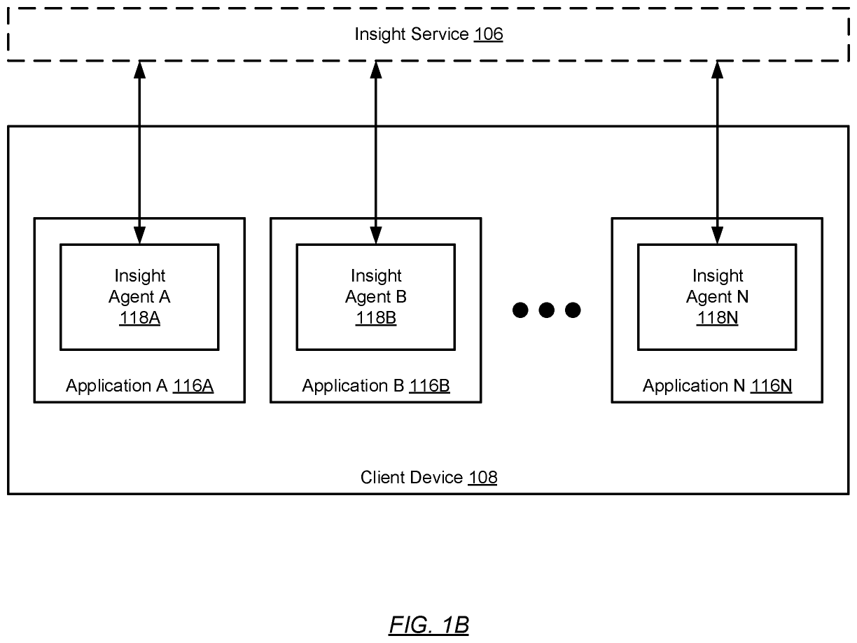

In the following description of FIGS. 1A-5C, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to insight lineage tracking. Any insight may be defined as a finding (or more broadly, as useful knowledge) gained through data analytics or, more precisely, through the discovery of patterns and/or relationships amongst any given assortment of data/information. Accordingly, any insight may be derived, or inferred, from any number of data/information items, including any number of other insights, as well as any number of employed analytic algorithms or models. In aiming to track these insight-pertinent objects, as well as the dependencies there-between, embodiments disclosed herein create insight lineage graphs visually conveying said objects and dependencies and, moreover, maintain metadata descriptive of each step in an insight creation process leading to the production of insights.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

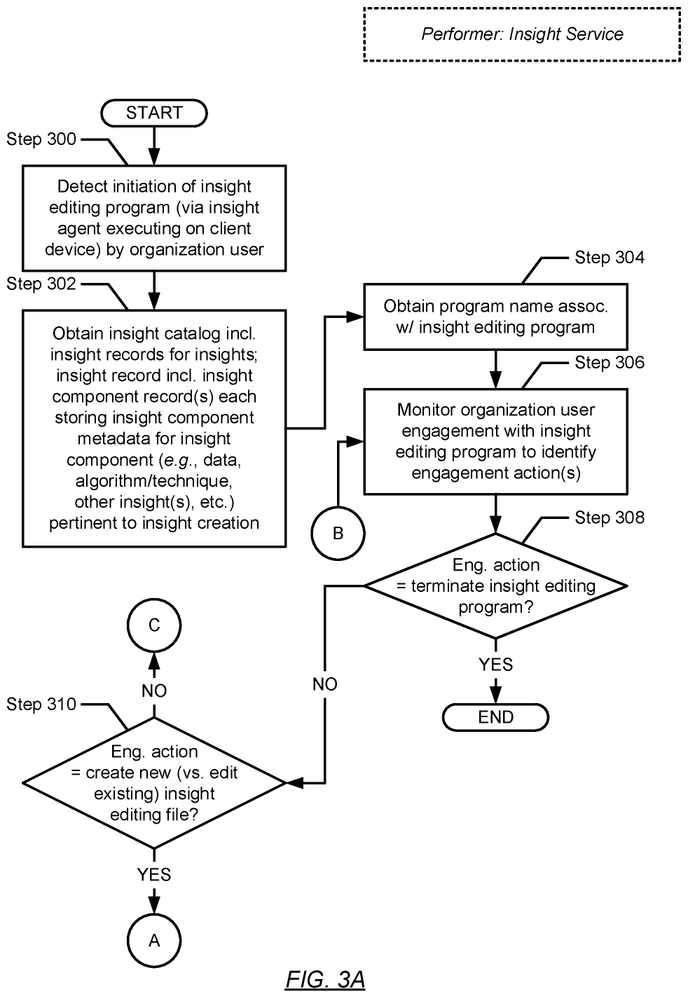

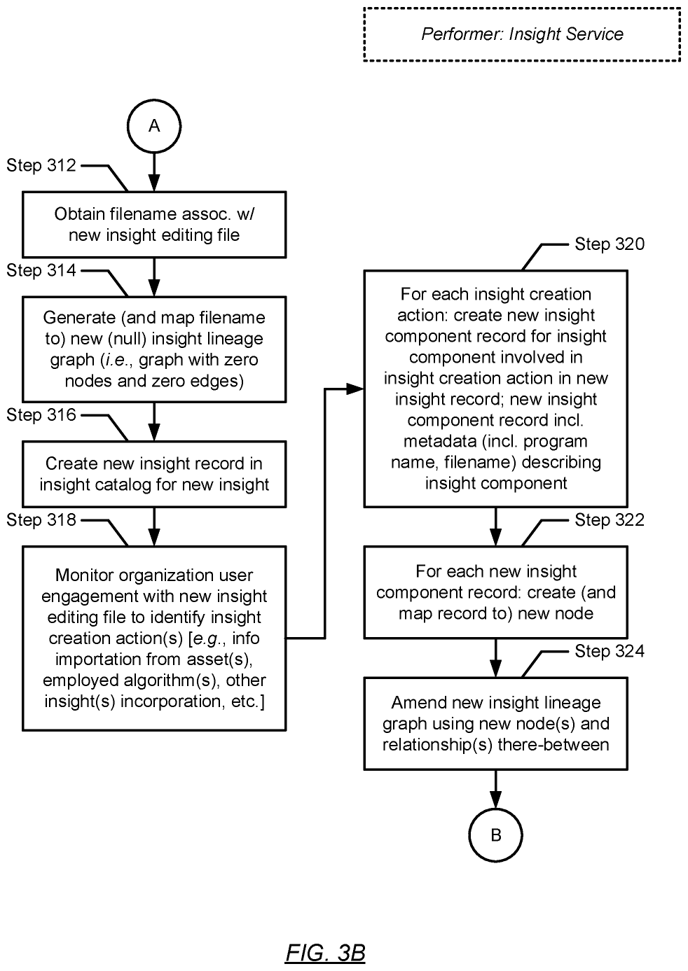

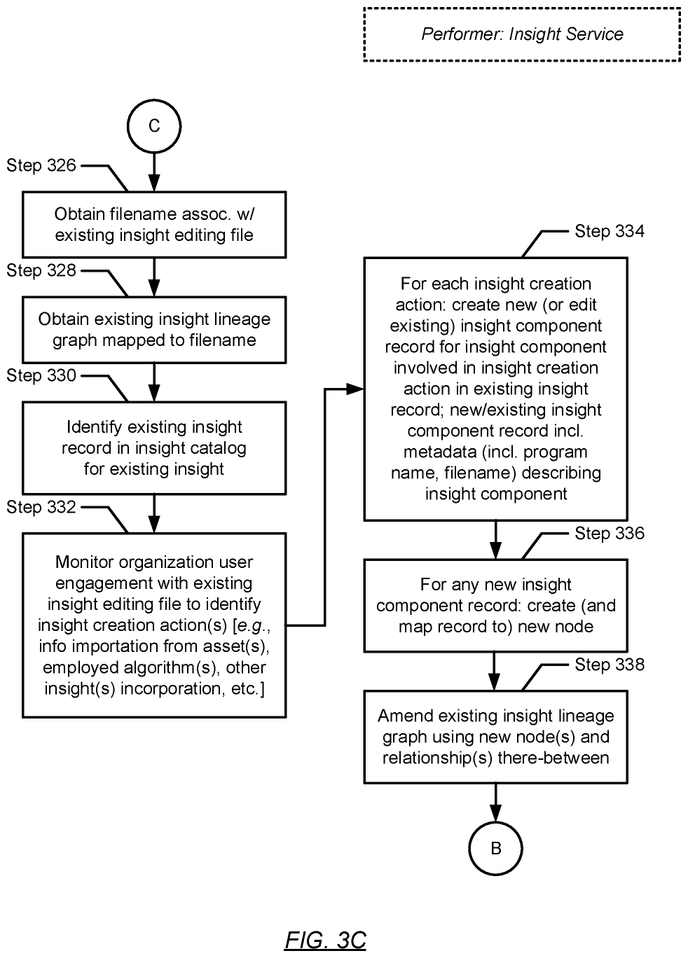

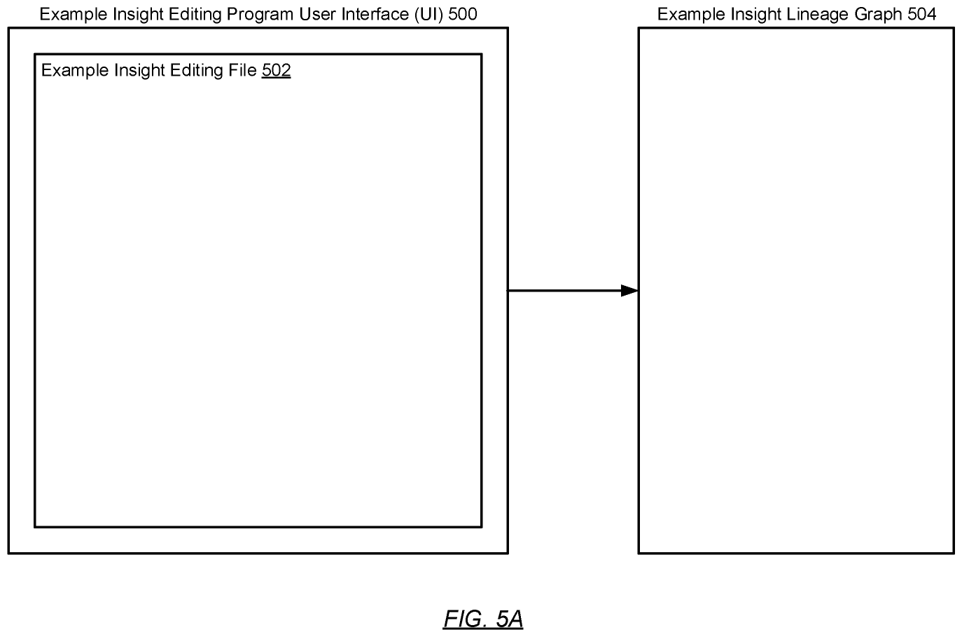

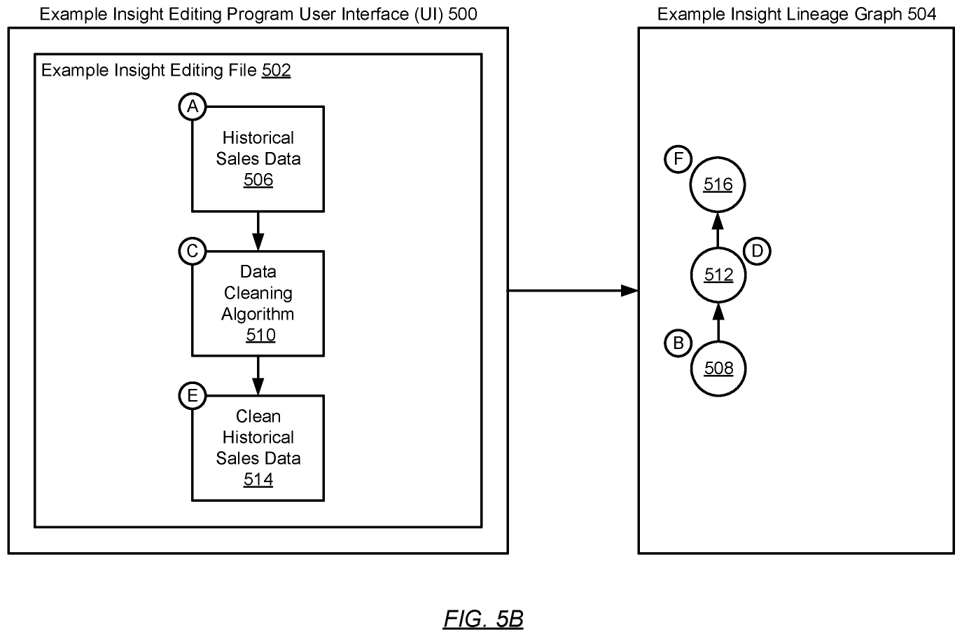

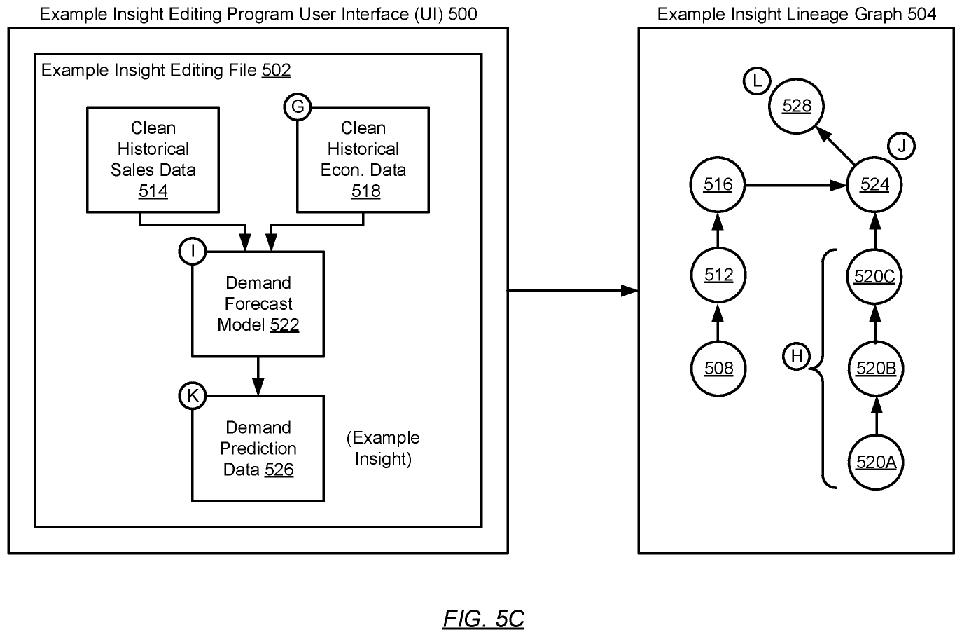

In one or many embodiment(s) disclosed herein, the insight service (106) may be configured with various capabilities or functionalities directed to digitally-assisted organization strategy. Said capabilities/functionalities may include: insight lineage tracking, as described in FIGS. 3A-3C as well as exemplified in FIGS. 5A-5C, below. Further, the insight service (106) may perform other capabilities/functionalities without departing from the scope disclosed herein.

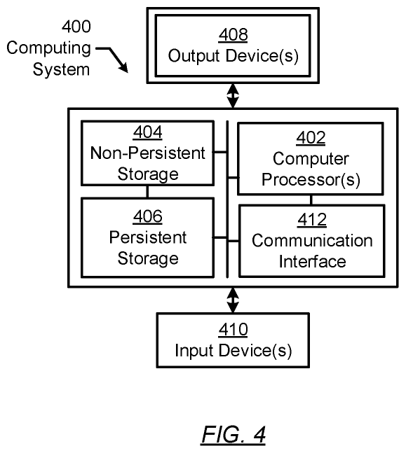

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

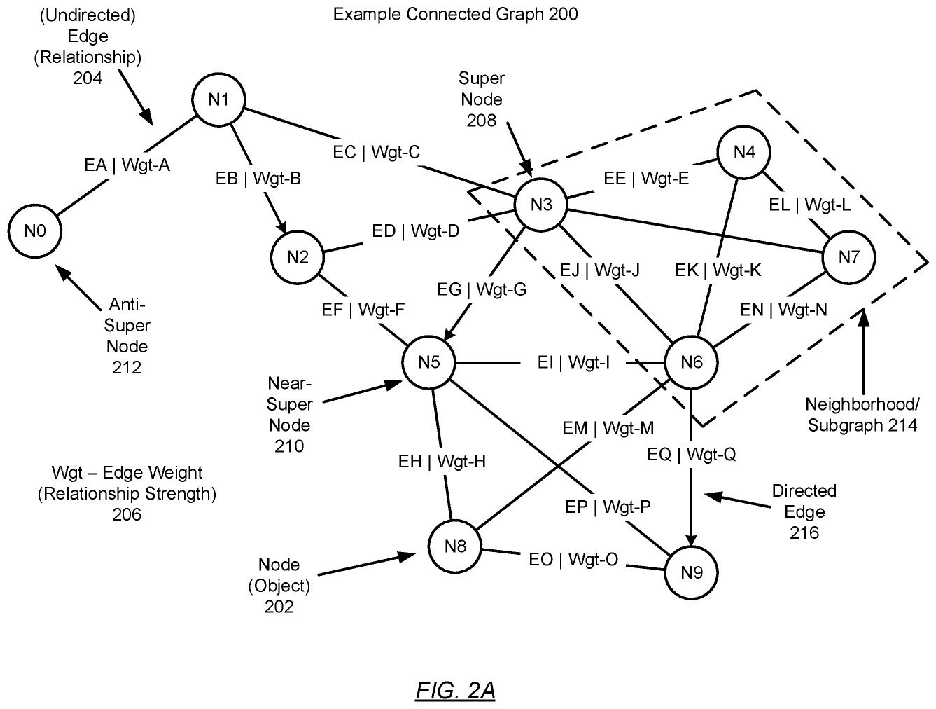

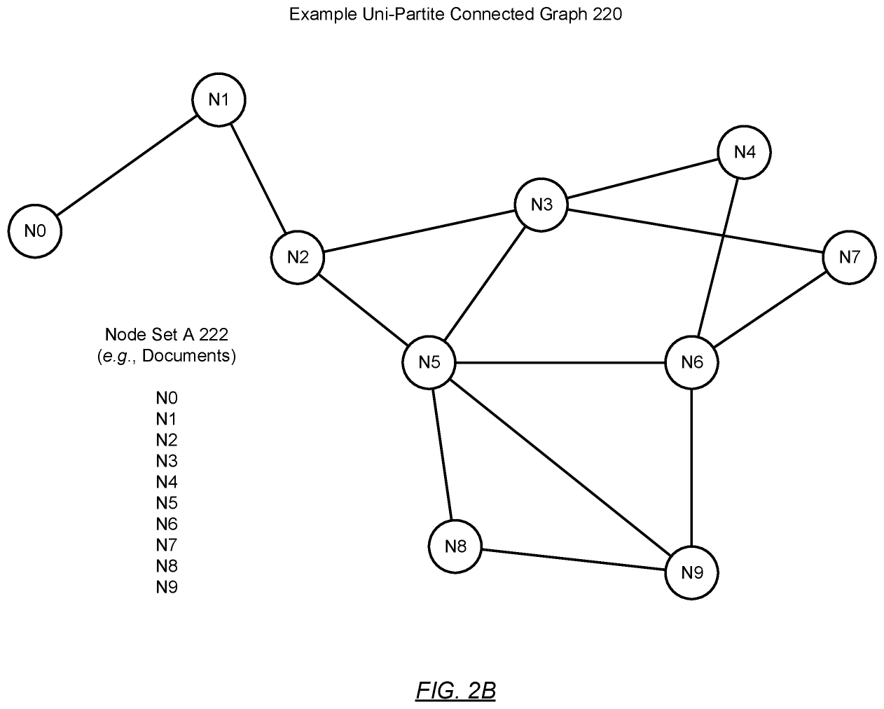

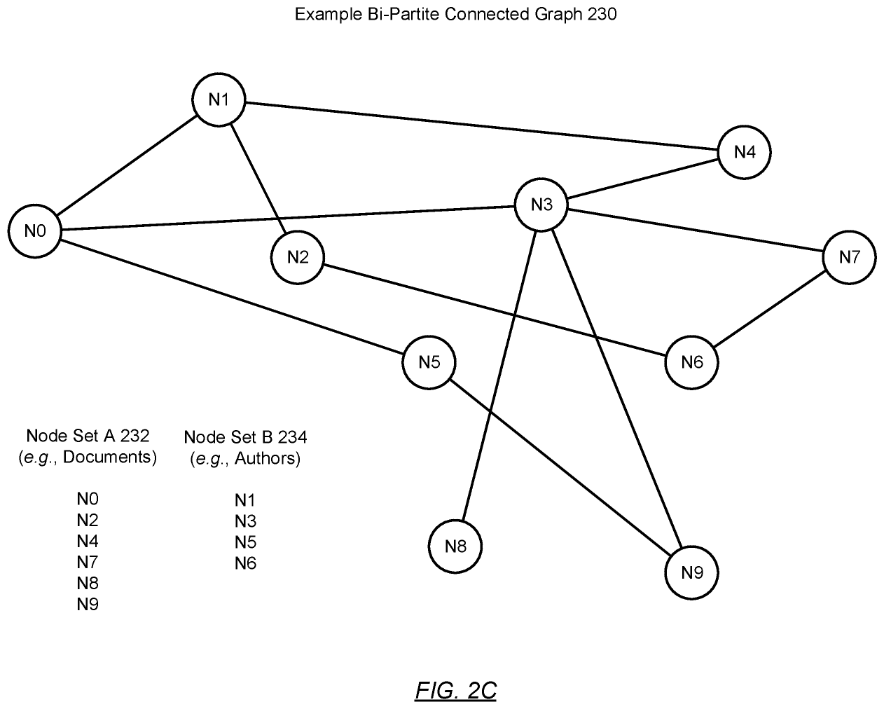

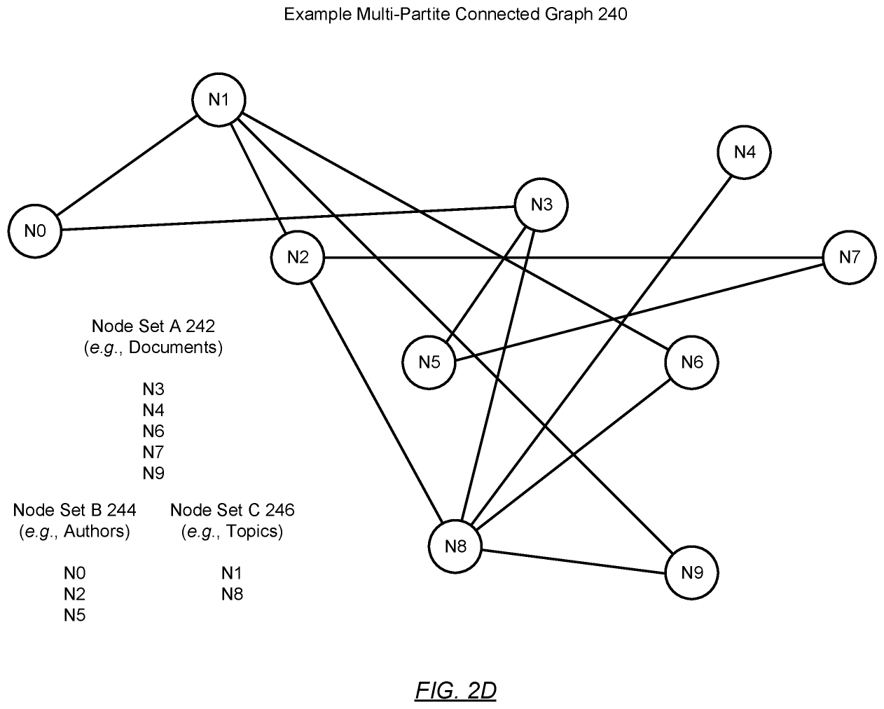

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled N0, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled NO, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled NO, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIGS. 3A-3C show flowcharts describing a method for insight lineage tracking in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, an initiation of an insight editing program, by an organization user, is detected. In one or many embodiment(s) disclosed herein, the insight editing program may refer to any software application configured for insight (described below) creation and/or editing. Examples of the insight editing program may include, an artificial intelligence and/or machine learning based inference computer program, a text editor, a spreadsheet editor, a presentation editor, an integrated development environment (IDE), an audio editor, a video editor, and an image and/or graphic editor. The insight editing program is not limited to the aforementioned specific examples. Further, detection of the initiation of the insight editing program may, for example, involve the receiving of telemetry from one or more insight agents (see e.g., FIG. 1B) executing on a client device operated by the organization user, where the insight editing program also executes on the aforementioned client device. The insight agent(s), accordingly, may be embedded within, or may otherwise be associated with, the insight editing program.

In one or many embodiment(s) disclosed herein, an insight may be defined as a finding (or more broadly, as useful knowledge) gained through data analytics or, more precisely, through the discovery of patterns and/or relationships amongst any given assortment of data/information. Moreover, an insight may take form through any existing data/information format—examples of which may include tabular data (e.g., a dataset), text, a data graphic (e.g., a chart) visualizing tabular data, an image, an audio track, and a video clip. The form (or format) of any insight is not limited to the aforementioned specific examples.

In Step 302, an insight catalog is obtained. In one or many embodiment(s) disclosed herein, the insight catalog may represent a data structure configured to maintain insight component metadata that describes one or more creation aspects (also referred to herein as insight component(s)) pertaining to a set of existing insights. Each existing insight, in the set of existing insights, may refer to an insight of which a respective insight creation process has already begun either by an organization user (e.g., the same or a different organization user as the organization user whom initiated the insight editing program detected in Step 300) or the insight service. Further, the insight catalog may include, and may thus be organized through, a set of insight records, where each insight record corresponds to a given existing insight in the set of existing insights. Each insight record, moreover, may include (individual) insight metadata (described below) and a set of insight component records, where each insight component record: corresponds to a given insight component, in a set of insight components, associated with a given existing insight to which the insight record corresponds; and stores (individual) insight component metadata (described below) particular to the given insight component to which the insight component record corresponds.

In one or many embodiment(s) disclosed herein, any insight component, associated with any given insight, may reference an object that contributed to the creation of the given insight. Examples of any object that may be referenced by any insight component, associated with any given insight, may include: any structured or unstructured form of information (e.g., tabular data or a dataset, text, a data graphic visualizing tabular data, an image, an audio track, a video clip, etc.); any information processing algorithm (e.g., a machine learning model, a dataset editing algorithm, a text editing algorithm, an image editing algorithm, an audio editing algorithm, a video editing algorithm, etc.) configured to process one or more forms of information; and any other insight (i.e., that is not the given insight with which the insight component is originally associated). Further, any insight component is not limited to the aforementioned specific examples.

Examples of (individual) insight component metadata, respective to any given insight component, may include: a program name associated with any insight editing program within which a creation, importation, editing, and/or processing of an object (described and exemplified above) referenced by the given insight component may be enabled/facilitated; a filename associated with an insight editing file within which the object referenced by the given insight component had been (or is being) created, imported, edited, and/or processed; the object (or a storage location thereof) to which the given insight component references; author(s) who created or embedded the given insight within another asset (e.g., a document, a presentation, a talk, a video, a meeting transcript, meeting notes, etc.,), which allows for the re-ingestion of the given asset into the asset catalog with references to the original insight(s) or asset(s) as to help not bias the data and models on which the insight service relies to derive or infer insights (including the given insight), where the context of the use of the asset(s) or insight(s) are calculated to verify and construct additional relationships to other nodes or even the creation of other nodes; data that was used to create any asset or any insight; any data as well as any machine learning and/or AI models that were used to generate knowledge from said data; and context that was created or determined from how asset(s) and insight(s) are used. Furthermore, the (individual) insight component metadata, respective to any given insight component, is not limited to the aforementioned specific examples.

Examples of (individual) insight metadata, respective to any given insight, may include: a storage location at which the given insight may be stored; at least a portion of any available insight editing file metadata (e.g., author, creation timestamp, last modified timestamp, etc.) describing the insight editing file within which the given insight had been (or is being) created and/or edited; an insight lineage graph (described below) (or a storage location thereof) associated with the given insight; context in how the given insight was used such as via talks, meetings, papers, etc.; how many times the given insight is re-used (e.g., a count of re-uses of the given insight in a same context, and/or a count of re-uses of the given insight in a different context); how the given insight is being displayed (e.g., via a type of chart, text, images, etc.) to help with understanding the context, which may serve to not bias the data and/or inference models that the insight service relies on to generate insights. Further, the (individual) insight metadata, respective to any given insight, is not limited to the aforementioned specific examples.

In Step 304, a program name is obtained. In one or many embodiment(s) disclosed herein, the program name may be associated with insight editing program, which had been initiated by the organization user (as detected in Step 300).

In Step 306, engagement (or interaction) with the insight editing program is monitored. In one or many embodiment(s) disclosed herein, said engagement/interaction may be performed by the organization user whom initiated the insight editing program (detected in Step 300) and may refer to any number of engagement actions through which the organization user engages/interacts with, or employs one or more features of, the insight editing program. Examples of said engagement actions may include, but are not limited to, terminating the insight editing program, creating a new insight editing file, and editing an existing insight editing file. The organization user may interact with the insight editing program through other engagement actions not explicitly described hereinafter without departing from the scope disclosed herein.

In Step 308, based on the insight editing program engagement (monitored in Step 306), a determination is made as to whether any engagement action reflects a terminating of the insight editing program. The organization user may terminate the insight editing program by, for example, closing a user interface for, associated with, or representative of the insight editing program. As such, in one or many embodiment(s) disclosed herein, if it is determined that any engagement action terminates the insight editing program, then the method ends. On the other hand, in one or many other embodiment(s) disclosed herein, if it is alternatively determined that any engagement action does not terminate the insight editing program, then the method alternatively proceeds to Step 310.

In Step 310, following the determination (made in Step 308) that any engagement action, based on the insight editing program engagement (monitored in Step 306), does not terminate the insight editing program, a determination is made as to whether said any engagement action reflects a creating of a new insight editing file. As such, in one or many embodiment(s) disclosed herein, if it is determined that any engagement action creates a new insight editing file, then the method proceeds to Step 312 (see e.g., FIG. 3B). On the other hand, in one or many other embodiment(s) disclosed herein, if it is alternatively determined that any engagement action does not create a new insight editing file (but rather reflects an editing of an existing insight editing file), then the method alternatively proceeds to Step 326 (see e.g., FIG. 3C).

Turning to FIG. 3B, in Step 312, following the determination (made in Step 310) that any engagement action, based on the insight editing program engagement (monitored in Step 306), creates a new insight editing file, a filename is obtained. In one or many embodiment(s) disclosed herein, the filename may be associated with the newly created insight editing file, which may be provided by the organization user.

In Step 314, a new insight lineage graph is generated. In one or many embodiment(s) disclosed herein, an insight lineage graph may refer to a connected graph (see e.g., FIG. 2A) representative of insight record (or, more specifically, of a set of insight component records thereof). To that end, an insight lineage graph may include a set of nodes interconnected by a set of edges, where the set of nodes are representative of (and thus map/correspond to) the set of insight component records (described above—see e.g., Step 302) and the set of edges are representative of connections or relationships there-between. Further, each node may pertain to a given object (described/exemplified above—see e.g., Step 302) referenced by a given insight component of the insight, where the representative insight component record thereof may store insight component metadata for, or information descriptive of, the given insight component and/or the referenced given object.

In one or many embodiment(s) disclosed herein, an insight lineage graph, for any given insight, may visually convey the dependencies amongst a set of objects that contributed towards the creation and/or editing of said given insight. For an example insight lineage graph, as well as a construction thereof based on a set of objects and their respective dependencies, refer to the example scenario illustrated and described with respect to FIGS. 5A-5C, below.

In one or many embodiment(s) disclosed herein, the new insight lineage graph (generated in Step 314), however, may reflect a null graph. A null graph may generally refer to an empty graph space that includes zero nodes and zero edges. Once the empty graph space is amended to include, or is occupied with, at least one node, the (new) insight lineage graph may transition from a null graph to a non-null graph. A non-null graph, in contrast to a null graph, may generally refer to a non-empty graph space that includes at least one node. One or more edges may only begin to be included, or otherwise occupy, a non-null graph once two or more nodes are also present for the edge(s) to interconnect. Further, following generation of the new insight lineage graph, the new insight lineage graph may be mapped to the filename (obtained in Step 312).

In Step 316, a new insight record is created for an insight of which an insight creation process, respective thereto, has yet to begin. In one or many embodiment(s) disclosed herein, the new insight record may be maintained in the insight catalog (obtained in Step 302) and may, for example, initially specify or include the new insight lineage graph (generated in Step 314) (or a storage location thereof).

In Step 318, engagement (or interaction) with the new insight editing file (created via the determination made in Step 310) is monitored. In one or many embodiment(s) disclosed herein, said engagement/interaction may be performed by the organization user whom initiated the insight editing program (detected in Step 300) and may refer to any number of insight creation actions through which the organization user engages/interacts with, or employs one or more features of, the new insight editing file. Examples of said insight creation actions may include, but are not limited to, manually entering or composing one or more items of data/information within the new insight editing file; applying one or more information processing algorithms (described above—see e.g., Step 302), within the new insight editing file, to at least one item of data/information, thereby resulting in the production of one or more processed items of data/information (which may or may not include the insight); and importing, into the new insight editing file, one or more other (existing) insights. The organization user may interact with the new insight editing file through other insight creation actions not explicitly described herein without departing from the scope disclosed herein.

In Step 320, for any given insight creation action (identified in Step 318) based on the new insight editing file engagement (monitored also in Step 318), one or more new insight component records is/are created. In one or many embodiment(s) disclosed herein, the new insight component record(s) may be maintained in the new insight record (created in Step 316) and may pertain to an insight component (described above—see e.g., Step 302) involved in the given insight creation action.

For example, if the given insight creation action reflects a manual entering or composing of an item of data/information, the involved insight component(s) may include a sole insight component referencing the manually entered/composed item of data/information. By way of another example, if the given insight creation action reflects an applying of an information processing algorithm to at least one item of data/information, which results in a producing of at least one processed item of data/information, the involved insight component(s) may include a first insight component referencing the information processing algorithm and at least one second insight component referencing the at least one processed item of data/information, respectively. By way of yet another example, if the given insight creation action reflects an importing of another (existing) insight, the involved insight component(s) may include a set of insight components associated with the other (existing) insight, where each insight component, in the set of insight components, may reference a manually entered/composed item of data/information, an information processing algorithm, or yet another (existing) insight.

In one or more embodiment(s) disclosed herein, creation of the new insight component record(s), for any given insight creation action (identified in Step 318) based on the new insight editing file engagement (monitored also in Step 318), may entail different procedures depending on the given insight creation action.

For example, if the given insight creation action reflects a manual entering or composing of an item of data/information, a single, new insight component record may be created. In such an example, the single, new insight component record may map/correspond to the insight component referencing the manually entered/composed item of data/information and, accordingly, may specify or include insight component metadata describing the insight component (or, more specifically, the object (i.e., the manually entered/composed item of data/information) to which the insight component references). Examples of (individual) insight component metadata, which may be specified/included in the single, new insight component record, may be disclosed above with respect to Step 302.

By way of another example, if the given insight creation action reflects an applying of an information processing algorithm to at least one item of data/information, which results in a producing of at least one processed item of data/information, at least two new insight component records may be created. In such an example, a first new insight component record (of the at least two new insight component records) may map/correspond to a first insight component referencing the information processing algorithm and, accordingly, may specify or include (individual) insight component metadata describing the first insight component (or, more specifically, the object (i.e., the information processing algorithm) to which the insight component references). Further, each remaining (e.g., second, third, fourth, etc.) new insight component record (of the at least two new insight component records) may map/correspond to a given remaining (e.g., second, third, fourth, etc.) insight component referencing a given processed item of data/information (of the at least one processed item of data/information) and, accordingly, may specify or include (individual) insight component metadata describing the given remaining insight component (or, more specifically, the object (i.e., the given processed item of data/information) to which the given remaining insight component references). Examples of (individual) insight component metadata, which may be specified/included in each of the at least two new insight component records, may be disclosed above with respect to Step 302.

By way of yet another example, if the given insight creation action reflects an importing of another (existing) insight, a set of new insight component records may be created. In such an example, the set of new insight component records may refer to copies of a set of existing insight component records associated with the other (existing) insight. Creation of the set of new insight component records, accordingly, may entail: identifying an (existing) insight record, maintained in the insight catalog (obtained in Step 302), that maps/corresponds to the other (existing) insight; identifying the set of existing insight component records maintained in the identified (existing) insight record; and copying/appending the identified set of existing insight component records into/to the new insight record (created in Step 316). Each existing insight component record, in the set of existing insight component records, may map/correspond to an insight component that references an object (e.g., a manually entered/composed item of data/information, an information processing algorithm, or yet another (existing) insight) that contributed to the creation of the other (existing) insight and, via the given insight creation action reflecting an importing thereof, now also contributes to the creation of the new insight being created. Further, each existing insight component record, in the set of existing insight component records, may specify or include (individual) insight component metadata describing a respective given insight component (or, more specifically, the object (i.e., a manually entered/composed item of data/information, an information processing algorithm, or yet another (existing) insight) to which the respective given insight component references). Examples of (individual) insight component metadata, which may be specified/included in each of existing insight component record (in the set of existing insight component records), may be disclosed above with respect to Step 302.

In Step 322, for each new insight component record, of the new insight component record(s) (created in Step 320), a new node is created. In one or many embodiment(s) disclosed herein, the new node may refer to a non-null graph (described above—see e.g., Step 314) element that, at least in part, forms the non-null graph (e.g., an insight lineage graph including at least one node). Further, following creation of the new node for each new insight component record, the respective new insight component record may be mapped to the new node.

In Step 324, the new insight lineage graph (generated in Step 314) is amended or updated using the new node(s) (created in Step 322). In one or many embodiment(s) disclosed herein, said amending/updating of the new insight lineage graph may at least entail insertion of the new node(s) into the empty graph space defining a null graph of which the new insight lineage graph had been reflective. In one or many other embodiment(s) disclosed herein, if a cardinality or number of the new nodes exceeds one, then said amending/updating of the new insight lineage graph may further entail insertion of one or more directed edges. Each directed edge may refer to an edge that connects a pair of new nodes and, also, specifies a direction from one new node (of the pair of new nodes) to another new node (of the pair of new nodes). For said pair of new nodes connected by a given directed edge, the given directed edge may visually convey a dependency (e.g., applied to, results in, etc.) one of the new nodes (of the pair of new nodes) has on the other of the new nodes (of the pair of new nodes).

From Step 324, the method proceeds to Step 306, where further engagement, by the organization user and with the insight editing program, is monitored.

Turning to FIG. 3C, in Step 326, following the alternative determination (made in Step 310) that any engagement action, based on the insight editing program engagement (monitored in Step 306), edits an existing insight editing file, a filename is obtained. In one or many embodiment(s) disclosed herein, the filename may be associated with the existing insight editing file, which may be provided by the organization user.

In Step 328, an existing insight lineage graph is obtained. In one or many embodiment(s) disclosed herein, an insight lineage graph may refer to a connected graph (see e.g., FIG. 2A) representative of insight record (or, more specifically, of a set of insight component records thereof). To that end, an insight lineage graph may include a set of nodes interconnected by a set of edges, where the set of nodes are representative of (and thus map/correspond to) the set of insight component records (described above—see e.g., Step 302) and the set of edges are representative of connections or relationships there-between. Further, each node may pertain to a given object (described/exemplified above—see e.g., Step 302) referenced by a given insight component of the insight, where the representative insight component record thereof may store insight component metadata for, or information descriptive of, the given insight component and/or the referenced given object.

In one or many embodiment(s) disclosed herein, an insight lineage graph, for any given insight, may visually convey the dependencies amongst a set of objects that contributed towards the creation and/or editing of said given insight. For an example insight lineage graph, as well as a construction thereof based on a set of objects and their respective dependencies, refer to the example scenario illustrated and described with respect to FIGS. 5A-5C, below.

In one or many embodiment(s) disclosed herein, the existing insight lineage graph (obtained in Step 328) may reflect a null graph or a non-null graph depending on a current creation progression of an insight that had been (or is being) created and/or edited. A null graph may generally refer to an empty graph space that includes zero nodes and zero edges. Once the empty graph space is amended to include, or is occupied with, at least one node, the (new) insight lineage graph may transition from a null graph to a non-null graph. A non-null graph, in contrast to a null graph, may generally refer to a non-empty graph space that includes at least one node. One or more edges may only begin to be included, or otherwise occupy, a non-null graph once two or more nodes are also present for the edge(s) to interconnect. Further, the existing insight lineage graph may be obtained through a mapping therefrom to the filename (obtained in Step 326).

In Step 330, an existing insight record is identified for an (existing) insight of which an insight creation process, respective thereto, has begun and is ongoing (or has completed and is currently being adjusted). In one or many embodiment(s) disclosed herein, the existing insight record may be maintained in the insight catalog (obtained in Step 302).

In Step 332, engagement (or interaction) with the existing insight editing file (edited via the determination made in Step 310) is monitored. In one or many embodiment(s) disclosed herein, said engagement/interaction may be performed by the organization user whom initiated the insight editing program (detected in Step 300) and may refer to any number of insight creation actions through which the organization user engages/interacts with, or employs one or more features of, the existing insight editing file. Examples of said insight creation actions may include, but are not limited to, manually entering or composing one or more items of data/information within the existing insight editing file; applying one or more information processing algorithms (described above—see e.g., Step 302), within the existing insight editing file, to at least one item of data/information, thereby resulting in the production of one or more processed items of data/information (which may or may not include the insight); and importing, into the existing insight editing file, one or more other (existing) insights. The organization user may interact with the existing insight editing file through other insight creation actions not explicitly described herein without departing from the scope disclosed herein.

In Step 334, for any given insight creation action (identified in Step 332) based on the existing insight editing file engagement (monitored also in Step 332), one or more new insight component records is/are created and/or one or more existing insight component records is/are edited. In one or many embodiment(s) disclosed herein, the new and/or existing insight component record(s) may be maintained in the existing insight record (identified in Step 330) and may pertain to an insight component (described above—see e.g., Step 302) involved in the given insight creation action.

For example, if the given insight creation action reflects a manual entering or composing of an item of data/information, the involved insight component(s) may include a sole insight component referencing the manually entered/composed item of data/information. By way of another example, if the given insight creation action reflects an applying of an information processing algorithm to at least one item of data/information, which results in a producing of at least one processed item of data/information, the involved insight component(s) may include a first insight component referencing the information processing algorithm and at least one second insight component referencing the at least one processed item of data/information, respectively. By way of yet another example, if the given insight creation action reflects an importing of another (existing) insight, the involved insight component(s) may include a set of insight components associated with the other (existing) insight, where each insight component, in the set of insight components, may reference a manually entered/composed item of data/information, an information processing algorithm, or yet another (existing) insight.

In one or more embodiment(s) disclosed herein, creation of any new insight component record(s), for any given insight creation action (identified in Step 332) based on the existing insight editing file engagement (monitored also in Step 332), may entail different procedures depending on the given insight creation action.

For example, if the given insight creation action reflects a manual entering or composing of an item of data/information, a single, new insight component record may be created. In such an example, the single, new insight component record may map/correspond to the insight component referencing the manually entered/composed item of data/information and, accordingly, may specify or include insight component metadata describing the insight component (or, more specifically, the object (i.e., the manually entered/composed item of data/information) to which the insight component references). Examples of (individual) insight component metadata, which may be specified/included in the single, new insight component record, may be disclosed above with respect to Step 302.

By way of another example, if the given insight creation action reflects an applying of an information processing algorithm to at least one item of data/information, which results in a producing of at least one processed item of data/information, at least two new insight component records may be created. In such an example, a first new insight component record (of the at least two new insight component records) may map/correspond to a first insight component referencing the information processing algorithm and, accordingly, may specify or include (individual) insight component metadata describing the first insight component (or, more specifically, the object (i.e., the information processing algorithm) to which the insight component references). Further, each remaining (e.g., second, third, fourth, etc.) new insight component record (of the at least two new insight component records) may map/correspond to a given remaining (e.g., second, third, fourth, etc.) insight component referencing a given processed item of data/information (of the at least one processed item of data/information) and, accordingly, may specify or include (individual) insight component metadata describing the given remaining insight component (or, more specifically, the object (i.e., the given processed item of data/information) to which the given remaining insight component references). Examples of (individual) insight component metadata, which may be specified/included in each of the at least two new insight component records, may be disclosed above with respect to Step 302.

By way of yet another example, if the given insight creation action reflects an importing of another (existing) insight, a set of new insight component records may be created. In such an example, the set of new insight component records may refer to copies of a set of existing insight component records associated with the other (existing) insight. Creation of the set of new insight component records, accordingly, may entail: identifying another (existing) insight record, maintained in the insight catalog (obtained in Step 302), that maps/corresponds to the other (existing) insight; identifying the set of existing insight component records maintained in the identified other (existing) insight record; and copying/appending the identified set of existing insight component records into/to the existing insight record (identified in Step 330). Each existing insight component record, in the set of existing insight component records, may map/correspond to an insight component that references an object (e.g., a manually entered/composed item of data/information, an information processing algorithm, or yet another (existing) insight) that contributed to the creation of the other (existing) insight and, via the given insight creation action reflecting an importing thereof, now also contributes to the creation of the existing insight being edited. Further, each existing insight component record, in the set of existing insight component records, may specify or include (individual) insight component metadata describing a respective given insight component (or, more specifically, the object (i.e., a manually entered/composed item of data/information, an information processing algorithm, or yet another (existing) insight) to which the respective given insight component references). Examples of (individual) insight component metadata, which may be specified/included in each of existing insight component record (in the set of existing insight component records), may be disclosed above with respect to Step 302.

In Step 336, for each new insight component record, of any new insight component record(s) (created in Step 334), a new node is created. In one or many embodiment(s) disclosed herein, the new node may refer to a non-null graph (described above—see e.g., Step 328) element that, at least in part, forms the non-null graph (e.g., an insight lineage graph including at least one node). Further, following creation of the new node for each new insight component record, the respective new insight component record may be mapped to the new node.

In Step 338, the existing insight lineage graph (identified in Step 328) is amended or updated using the new node(s) (created in Step 336). In one or many embodiment(s) disclosed herein, said amending/updating of the existing insight lineage graph may at least entail insertion of the new node(s) into the empty graph space defining a null graph, or the non-empty graph space defining a non-null graph, of which the existing insight lineage graph had been reflective. In one or many other embodiment(s) disclosed herein, if the existing insight lineage graph reflects a null graph and a cardinality or number of the new nodes exceeds one, then said amending/updating of the existing insight lineage graph may further entail insertion of one or more directed edges. In one or many other embodiment(s) disclosed herein, if the existing insight lineage graph alternatively reflects a non-null graph and a cardinality or number of the new nodes exceeds zero, then said amending/updating of the existing insight lineage graph may or may not further entail insertion of one or more directed edges based on the relationship(s) (e.g., dependency/dependencies) between the inserted new node(s). Each directed edge may refer to an edge that connects a pair of new nodes and, also, specifies a direction from one new node (of the pair of new nodes) to another new node (of the pair of new nodes). For said pair of new nodes connected by a given directed edge, the given directed edge may visually convey a dependency (e.g., applied to, results in, etc.) one of the new nodes (of the pair of new nodes) has on the other of the new nodes (of the pair of new nodes).

From Step 338, the method proceeds to Step 306, where further engagement, by the organization user and with the insight editing program, is monitored.

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIGS. 5A-5C show an example scenario in accordance with one or more embodiments disclosed herein. The example scenario, illustrated through FIGS. 5A-5C and described below, is for explanatory purposes only and not intended to limit the scope disclosed herein.

Hereinafter, consider the following example scenario whereby an organization user, identified as Frank, seeks to create a new insight (e.g., in the form of a processed dataset). To that end, Frank initiates an insight editing program (e.g., an integrated development environment (IDE)) on his laptop computer (e.g., client device), where the insight editing program is configured to enable/facilitate the insight creation process of the new insight. Meanwhile, the Insight Service, in conjunction with an Insight Agent executing on the laptop computer and embedded within the insight editing program, follow embodiments disclosed herein pertaining to insight lineage tracking as applied to the circumstances of the example scenario.

Upon initiating the insight editing program, said initiation is detected by the Insight Service via the Insight Agent. Further, following said initiation, a user interface (UI) of the insight editing program (see e.g., example insight editing program UI 500 of FIG. 5A) loads and Frank, thereafter, opts to create a new insight editing file (e.g., a new computer program code file) (see e.g., example insight editing file 502 of FIG. 5A). The Insight Service subsequently creates a new insight record to be associated with the new insight, in an insight catalog maintained thereby, and also creates a new insight lineage graph (e.g., reflected, at least initially, as a null graph or an empty graph space) (see e.g., example insight lineage graph 504 of FIG. 5A) to track and visually convey a creation lineage to be associated with the new insight.

From here, Frank proceeds to engage or interact with the new insight editing file in order to create the new insight. The Insight Service, via the Insight Agent, monitors the performed engagements/interactions to identify a series of insight creation actions. The identified insight creation actions, as well as any insight lineage tracking actions performed by the Insight Service in response to said insight creation actions, are illustrated in conjunction with components shown across FIGS. 5B and 5C, and also described (in an itemized manner), below.

Turning to FIG. 5B:
A. User Frank, via the insight editing program UI (500), manually enters some historical sales data (506) into/within the new insight editing file (502)
B. In response to identifying a first insight creation action reflecting a manual entering of data/information, the Insight Service creates a first new insight component record (in the new insight record) (not shown) for a first insight component referencing the historical sales data (506); further, the Insight Service creates a first new node (508) mapping/corresponding to the first new insight component record and, then, amends/updates the insight lineage graph (504) by inserting the first new node (508) therein
C. User Frank, via the insight editing program UI (500), subsequently applies, while working within the new insight editing file (502), a data cleaning algorithm (510) to the historical sales data (506)
D. In response to identifying a second insight creation action reflecting an applying of an information processing algorithm, the Insight Service creates a second new insight component record (in the new insight record) (not shown) for a second insight component referencing the data cleaning algorithm (510); moreover, the Insight Service creates a second new node (512) mapping/corresponding to the second new insight component record, as well as a first new directed edge connecting the first new node (508) to the second new node (512), where the first new directed edge reflects that the data cleaning algorithm (510) is dependent on the historical sales data (506); next, the Insight Service amends/updates the insight lineage graph (504) by inserting the second new node (512) and the first new directed edge therein
E. In applying the data cleaning algorithm (510) to the historical sales data (506), clean historical sales data (514) results
F. As an extension of identifying the second insight creation action, the Insight Service additionally creates a third new insight component record (in the new insight record) (not shown) for a third insight component referencing the clean historical sales data (514); the Insight Service, subsequently, creates a third new node (516) mapping/corresponding to the third new insight component record, as well as a second new directed edge connecting the second new node (512) to the third new node (516), where the second new directed edge reflects that the clean historical sales data (514) is dependent on the data cleaning algorithm (510); afterwards, the Insight Service amends/updates the insight lineage graph (504) by inserting the third new node (516) and the second new directed edge therein

Turning to FIG. 5C:
G. User Frank imports some clean historical economy data (518) (e.g., another insight) into/within the new insight editing file (502)
H. In response to identifying a third insight creation action reflecting an importing of an/the other insight, the Insight Service creates a set (e.g. three (3)) of fourth new insight components records (in the new insight record) (not shown) representing copies of a set of existing insight records maintained in an identified existing insight record mapping/corresponding to the clean historical economy data (518); the Insight Service, thereafter, creates a set of fourth new nodes (520A, 520B, 520C) mapping/corresponding to the set of fourth new insight component records, as well as a third new directed edge connecting a first fourth new node (520A) to a second fourth new node (520B) and a fourth new directed edge connecting the second fourth new node (520B) to a third fourth new node (520C), where the third new directed edge reflects that a second object that contributed to the creation of the clean historical economy data (518) and mapped to the second fourth new node (520B) is dependent on a first object that contributed to the creation of the clean historical economy data (518) and mapped to the first fourth new node (520A), whereas the fourth new directed edge reflects that the clean historical economy data (518) mapped to the third fourth new node (520C) is dependent on the second object that contributed to the creation of the clean historical economy data (518) and mapped to the second fourth new node (520B); next, the Insight Service amends/updates the insight lineage graph (504) by inserting the set of fourth new nodes (520A, 520B, 520C), as well as the third and fourth new directed edges, therein
I. User Frank, via the insight editing program UI (500), subsequently applies, while working within the new insight editing file (502), a demand forecast model (522) to the clean historical sales data (514) and the clean historical economy data (518)
J. In response to identifying a fourth insight creation action reflecting an applying of an information processing algorithm, the Insight Service creates a fifth new insight component record (in the new insight record) (not shown) for a fifth insight component referencing the demand forecast model (522); moreover, the Insight Service creates a fifth new node (524) mapping/corresponding to the fifth new insight component record, as well as a fifth new directed edge connecting the third new node (516) to the fifth new node (524) and a sixth new directed edge connecting the third fourth new node (520C) to the fifth new node (524), where the fifth new directed edge reflects that the demand forecast model (522) is dependent on the clean historical sales data (514), whereas the sixth new directed edge reflects that the demand forecast model (522) is further dependent on the clean historical economy data (518); afterwards, the Insight Service amends/updates the insight lineage graph (504) by inserting the fifth new node (524), as well as the fifth and sixth new directed edges, therein
K. In applying the demand forecast model (522) to the clean historical sales data (514) and the clean historical economy data (518), demand prediction data (526) (e.g., representing the new insight sought to be created by User Frank) results
L. As an extension of identifying the fourth insight creation action, the Insight Service additionally creates a sixth new insight component record (in the new insight record) (not shown) for a sixth insight component referencing the demand prediction data (526); the Insight Service, subsequently, creates a sixth new node (528) mapping/corresponding to the sixth new insight component record, as well as a seventh new directed edge connecting the fifth new node (524) to the sixth new node (528), where the seventh new directed edge reflects that the demand prediction data (526) is dependent on the demand forecast model (522); afterwards, the Insight Service amends/updates the insight lineage graph (504) by inserting the sixth new node (528) and the seventh new directed edge therein

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for tracking insight lineage, the method comprising:
detecting an initiation, by an organization user, of an insight editing program;
monitoring interactions, by the organization user, with the insight editing program to identify an engagement action,
wherein the engagement action reflects a creating of an insight editing file to be associated with an insight;
generating an insight lineage graph reflecting a null graph;
mapping the insight lineage graph to the insight editing file;
monitoring second interactions, by the organization user, with the insight editing file to identify an insight creation action; and
amending, based on the insight creation action, the insight lineage graph to track an insight lineage for the insight.

2. The method of claim 1, wherein the insight creation action reflects a manual entering of a dataset within the insight editing file, and wherein amending, based on the insight creation action, the insight lineage graph to track the insight lineage for the insight, comprises:
creating an insight component referencing the dataset;
creating a node representative of the insight component; and
amending the insight lineage graph by inserting the node therein,
wherein, by inserting the node therein, the insight lineage graph transitions from a null graph to a non-null graph.

3. The method of claim 2, the method further comprising:
prior to monitoring the second interactions:
creating, in an insight catalog and for the insight, an insight record comprising insight metadata describing the insight.

4. The method of claim 3, wherein amending, based on the insight creation action, the insight lineage graph to track the insight lineage for the insight, further comprises:
creating, in the insight record and for the insight component, an insight component record comprising insight component metadata describing the insight component; and
mapping the insight component record to the node inserted in the insight lineage graph.

5. The method of claim 4, wherein monitoring the second interactions, by the organization user, with the insight editing file further identifies a second creation action, wherein the second creation action reflects an applying of a data processing algorithm to the dataset to produce a processed dataset, and wherein amending, based on the insight creation action, the insight lineage graph to track the insight lineage for the insight, further comprises:
creating a second insight component referencing the data processing algorithm;
creating a second node representative of the second insight component;
amending the insight lineage graph further by inserting the second node and a directed edge connecting the node to the second node therein;
creating a third insight component referencing the processed dataset;
creating a third node representative of the third insight component; and
amending the insight lineage graph further by inserting the third node and a second directed edge connecting the second node to the third node therein.

6. The method of claim 5, wherein amending, based on the insight creation action, the insight lineage graph to track the insight lineage for the insight, further comprises:
creating, in the insight record and for the second insight component, a second insight component record comprising second insight component metadata describing the second insight component;
mapping the second insight component record to the second node inserted in the insight lineage graph;
creating, in the insight record and for the third insight component, a third insight component record comprising third insight component metadata describing the third insight component; and
mapping the third insight component record to the third node inserted in the insight lineage graph.

7. The method of claim 3, wherein monitoring the second interactions, by the organization user, with the insight editing file further identifies a third creation action, wherein the third creation action reflects an importing of a second processed dataset representing a second insight, and wherein amending, based on the insight creation action, the insight lineage graph to track the insight lineage for the insight, further comprises:
obtaining a second insight lineage graph associated with the second insight; and
amending the insight lineage graph further by inserting the second insight lineage graph therein.

8. The method of claim 7, wherein amending, based on the insight creation action, the insight lineage graph to track the insight lineage for the insight, further comprises:
identifying, in the insight catalog, a second insight record for the second insight;
identifying, in the second insight record, a set of fourth insight component records for a set of fourth insight components, respectively,
wherein the set of fourth insight components each contributed to a creation of the second insight; and
appending, to the insight record, the set of fourth insight component records each comprising fourth component metadata describing a fourth insight component in the set of insight components.

9. The method of claim 8, wherein monitoring the second interactions, by the organization user, with the insight editing file further identifies a fourth creation action, wherein the fourth creation action reflects an applying of a second data processing algorithm to the processed dataset and the second processed dataset to produce a third processed dataset representing the insight, and wherein amending, based on the insight creation action, the insight lineage graph to track the insight lineage for the insight, further comprises:
identifying, from a set of fourth nodes forming the second insight lineage graph, a fourth node representative of the second processed dataset;
creating a fifth insight component referencing the second data processing algorithm;
creating a fifth node representative of the fifth insight component;
amending the insight lineage graph further by inserting the fifth node, a third directed edge connecting the third node to the fifth node, and a fourth directed edge connecting the fourth node to the fifth node therein;
creating a sixth insight component referencing the third processed dataset;
creating a sixth node representative of the sixth insight component; and
amending the insight lineage graph further by inserting the sixth node and a fifth directed edge connecting the fifth node to the sixth node therein.

10. The method of claim 9, wherein amending, based on the insight creation action, the insight lineage graph to track the insight lineage for the insight, further comprises:
creating, in the insight record and for the fifth insight component, a fifth insight component record comprising fifth insight component metadata describing the fifth insight component;
mapping the fifth insight component record to the fifth node inserted in the insight lineage graph;
creating, in the insight record and for the sixth insight component, a sixth insight component record comprising sixth insight component metadata describing the sixth insight component; and
mapping the sixth insight component record to the sixth node inserted in the insight lineage graph.

11. The method of claim 1, wherein monitoring the interactions, by the organization user, with the insight editing program further identifies a second engagement action, and wherein the second engagement action reflects an editing of a second insight editing file associated with a second insight.

12. A non-transitory computer readable medium (CRM) comprising computer readable program code, which when executed by a computer processor, enables the computer processor to perform a method for tracking insight lineage, the method comprising:
detecting an initiation, by an organization user, of an insight editing program;
monitoring interactions, by the organization user, with the insight editing program to identify an engagement action,
wherein the engagement action reflects a creating of an insight editing file to be associated with an insight;
generating an insight lineage graph reflecting a null graph;
mapping the insight lineage graph to the insight editing file;
monitoring second interactions, by the organization user, with the insight editing file to identify an insight creation action; and
amending, based on the insight creation action, the insight lineage graph to track an insight lineage for the insight.

13. The non-transitory CRM of claim 12, wherein the insight creation action reflects a manual entering of a dataset within the insight editing file, and wherein amending, based on the insight creation action, the insight lineage graph to track the insight lineage for the insight, comprises:
creating an insight component referencing the dataset;
creating a node representative of the insight component; and
amending the insight lineage graph by inserting the node therein,
wherein, by inserting the node therein, the insight lineage graph transitions from a null graph to a non-null graph.

14. The non-transitory CRM of claim 13, the method further comprising:
prior to monitoring the second interactions:
creating, in an insight catalog and for the insight, an insight record comprising insight metadata describing the insight.

15. The non-transitory CRM of claim 14, wherein amending, based on the insight creation action, the insight lineage graph to track the insight lineage for the insight, further comprises:
creating, in the insight record and for the insight component, an insight component record comprising insight component metadata describing the insight component; and
mapping the insight component record to the node inserted in the insight lineage graph.

16. The non-transitory CRM of claim 15, wherein monitoring the second interactions, by the organization user, with the insight editing file further identifies a second creation action, wherein the second creation action reflects an applying of a data processing algorithm to the dataset to produce a processed dataset, and wherein amending, based on the insight creation action, the insight lineage graph to track the insight lineage for the insight, further comprises:
creating a second insight component referencing the data processing algorithm;
creating a second node representative of the second insight component;
amending the insight lineage graph further by inserting the second node and a directed edge connecting the node to the second node therein;
creating a third insight component referencing the processed dataset;
creating a third node representative of the third insight component; and
amending the insight lineage graph further by inserting the third node and a second directed edge connecting the second node to the third node therein.

17. The non-transitory CRM of claim 16, wherein monitoring the second interactions, by the organization user, with the insight editing file further identifies a third creation action, wherein the third creation action reflects an importing of a second processed dataset representing a second insight, and wherein amending, based on the insight creation action, the insight lineage graph to track the insight lineage for the insight, further comprises:
obtaining a second insight lineage graph associated with the second insight; and
amending the insight lineage graph further by inserting the second insight lineage graph therein.

18. The non-transitory CRM of claim 17, wherein monitoring the second interactions, by the organization user, with the insight editing file further identifies a fourth creation action, wherein the fourth creation action reflects an applying of a second data processing algorithm to the processed dataset and the second processed dataset to produce a third processed dataset representing the insight, and wherein amending, based on the insight creation action, the insight lineage graph to track the insight lineage for the insight, further comprises:
identifying, from a set of fourth nodes forming the second insight lineage graph, a fourth node representative of the second processed dataset;
creating a fifth insight component referencing the second data processing algorithm;
creating a fifth node representative of the fifth insight component;
amending the insight lineage graph further by inserting the fifth node, a third directed edge connecting the third node to the fifth node, and a fourth directed edge connecting the fourth node to the fifth node therein;
creating a sixth insight component referencing the third processed dataset;
creating a sixth node representative of the sixth insight component; and
amending the insight lineage graph further by inserting the sixth node and a fifth directed edge connecting the fifth node to the sixth node therein.

19. The non-transitory CRM of claim 12, wherein monitoring the interactions, by the organization user, with the insight editing program further identifies a second engagement action, and wherein the second engagement action reflects an editing of a second insight editing file associated with a second insight.

20. A system, the system comprising:
a client device; and
an insight service operatively connected to the client device, and comprising a computer processor configured to perform a method for tracking insight lineage, the method comprising:
detecting an initiation, by an organization user operating the client device, of an insight editing program executing on the client device;
monitoring interactions, by the organization user, with the insight editing program to identify an engagement action,
wherein the engagement action reflects a creating of an insight editing file to be associated with an insight;
generating an insight lineage graph reflecting a null graph;
mapping the insight lineage graph to the insight editing file;
monitoring second interactions, by the organization user, with the insight editing file to identify an insight creation action; and
amending, based on the insight creation action, the insight lineage graph to track an insight lineage for the insight.
